(19) United States
(12) Patent Application Publication
(10) Pub. No.: US 2015/0369542 A1
(43) Pub. Date: Dec. 24, 2015

(54) METHOD OF PRODUCING A DEVICE FOR STORING THERMAL ENERGY BY SOLID/SOLID PHASE CHANGE MATERIAL

(71) Applicant: Commissariat A L'Energie Atomique et aux Energies Alternatives, Paris (FR)

(72) Inventors: Zoe MINVIELLE, Grenoble (FR); Raphael COUTURIER, Sassenage (FR)

(73) Assignee: Commissariat A L'Energie Atomique et aux Energies Alternatives, Paris (FR)

(21) Appl. No.: 14/740,407

(22) Filed: Jun. 16, 2015

(30) Foreign Application Priority Data
Jun. 18, 2014 (FR) 14 55581

(51) Int. Cl. F28D 20/02; B23P 15/26

(52) U.S. Cl. CPC F28D 20/021; B23P 15/26

(57) ABSTRACT

The invention relates to a method for producing a thermal energy storage device by means of at least one solid/solid phase change material, comprising a thermal energy storage chamber containing the at least one solid/solid phase change material and a heat exchanger of the heat-transfer fluid type for storing and extracting heat of said s/s PCM immersed in said chamber.

The invention will find its application in the field of the storage of thermal energy and for example for the application of storing heat in an urban or industrial heat system.

### FIELD OF THE INVENTION

The present invention relates to a method for producing a thermal energy storage device using solid/solid phase change material (s/s PCM).

The invention will find its application in the field of the storage of thermal energy. It will for example find as its application the storage of heat in an urban or industrial heating system.

### PRIOR ART

The storage of thermal energy, which consists of putting a quantity of energy in a given place to enable it to be used subsequently, is a perennial problem. Mastering the storage of energy is all the more important at the present time for optimising alternative energies, which are intermittent. It is therefore necessary to store this energy for subsequent use.

Phase change materials (PCMs) have been developed and are frequently used in buildings for accumulating solar thermal energy for individual solar water heaters. PCMs also smooth the production of energy supplied by alternative energies and increase the storage capacity by virtue of their high energy density per unit volume.

By means of the PCMs, the heat is absorbed or restored during a change of state. There exist four types of PCM transformations: gas/liquid, gas/solid, solid/solid and liquid/solid. For storing energy for buildings, it is liquid/solid transformations that are normally used. They have high phase change enthalpies and low volume expansions during fusion. For example, for liquid/solid PCMs, the material stores the heat when it passes from the solid state to the liquid state, and then it restores it when it passes from the liquid state to the solid state.

PCMs with solid/solid transition are beginning to be developed, in particular in construction. The fact that they are permanently solid makes it easy to package and use them. Furthermore, solid/solid phase change materials make it possible to store more heat than solid/liquid phase change materials.

The invention thus makes it possible to benefit from the high energy density of s/s PCMs.

Nevertheless, there still exists the need to improve the performances of s/s PCMs and to afford ever greater heat storage and restoration.

### DISCLOSURE OF THE INVENTION

The present invention proposes for this purpose a method for producing a thermal energy storage device in which at least one s/s PCM is formed directly in the energy storage chamber. Thus, according to the invention, the method for forming at least one s/s PCM is at least partially implemented in the energy storage chamber. Said storage chamber containing the s/s PCM formed is then used for thermal energy storage cycles by storing and then restoring heat in said s/s PCM. According to the present method, the energy storage chamber serves as a reactor for forming at least one s/s PCM. The handling of the s/s PCM is thereby limited since it is formed in the chamber that will be the storage chamber. Manufacture of the storage device is facilitated.

Preferentially, at least one step of crystallisation of the s/s PCM is performed in the chamber so that assembly of the chamber and device is optimum.

This is because introducing a liquid into the chamber and then changing it to the solid state by crystallisation allows total filling so that the void fraction of the chamber is as limited as possible.

The method according to the invention also has the advantage of obtaining a storage device having more efficient storage capacities than the devices of the prior art. This is because, according to the present method, the s/s PCM is not heated beyond its melting point, which preserves its chemical integrity and therefore its performances, unlike the s/s PCMs of the prior art, which are heated beyond their melting point so as to be liquefied.

Advantageously, the device comprises a heat exchanger of the heat-transfer fluid type arranged at least partially in said chamber. The heat exchanger makes it possible to control the temperature inside the chamber during the formation of the s/s PCM and then to provide and recover heat in the s/s PCM.

### BRIEF DESCRIPTION OF THE FIGURES

The aims, objects, features and advantages of the invention will emerge more clearly from the detailed description of an embodiment thereof that is illustrated by the following accompanying figures, in which:

FIG. 1: diagram of production of a device according to the invention with pentaerythritol as the s/s PCM.

FIG. 2: diagram of a thermal energy storage device comprising a heat exchanger with finned tubes.

FIG. 3: diagram of a thermal energy storage device comprising a coil-type heat exchanger.

### DETAILED DISCLOSURE OF PARTICULAR EMBODIMENTS

Before beginning a detailed review of embodiments of the invention, optional features, which may optionally be used in association or alternatively, are stated below.

It is stated first of all that the invention relates to a method for producing a thermal energy storage device by means of at least one solid/solid phase change material comprising a thermal energy storage chamber containing the at least one solid/solid phase change material and a heat exchanger, heat-transfer fluid for storing and extracting the heat of said s/s PCM, immersed in said chamber, characterised in that at least one step of forming at least one solid/solid phase change material is performed inside the storage chamber, the at least one formation step comprising at least one crystallisation step.

Advantageously, according to preferred but non-limitative variants, the invention is such that:

the at least one formation step comprises a concentration step performed inside the storage chamber;

the at least one formation step comprises a filtration step performed in the storage chamber;

the at least one formation step comprises a step of mixing the reagents performed in the storage chamber;

reagents for the formation of the at least one solid/solid phase change material are introduced into the chamber through at least one supply pipe;

liquid residues issuing from the formation of the at least one material are extracted from the chamber through at least one takeoff device;

the heat exchanger of the heat-transfer fluid type is used for controlling the temperature inside the chamber during the formation of at least one solid/solid phase change material;

the heat exchanger is configured so as to control the crystallisation of the solid/solid phase change material inside the chamber;

the at least one solid/solid phase change material is solubilised in a solvent and then introduced into the storage chamber, and then at least one step of crystallisation of the s/s PCM is performed inside the chamber;

a prior step of covering the interior metal walls of the chamber with a cladding material is intended to prevent contact between the at least one s/s PCM and the metal walls of the chamber;

a step of doping the at least one s/s PCM is performed in the chamber, for example in order to improve the thermal conductivity and/or to limit supercooling;

the at least one s/s PCM is pentaerythritol.

Advantageously, the method does not include any step of liquefaction of the s/s PCM by heating beyond its melting point.

Another subject matter of the invention is a method for producing a thermal energy storage installation on an operating site, characterised by the fact that it comprises:
the production of a thermal energy storage device according to the method as described previously;
transportation, onto the operating site, of the device produced, the chamber of which is filled with s/s PCM;
connection of the heat exchanger of the device to the fluid system for starting the thermal energy storage.

Another subject matter of the invention is a thermal energy storage device produced by the method as described previously, comprising a thermal energy storage chamber containing at least one s/s PCM and a heat exchanger of the heat-transfer fluid type at least partially disposed in the chamber, characterised by the fact that it comprises a device for regulating the temperature of the heat-transfer fluid so as to be configured in order:
in a configuration of formation of the at least one s/s PCM, to control the temperature of the heat-transfer fluid in order to cause crystallisation of the s/s PCM;
in a use configuration, to control the temperature of the heat-transfer fluid in order to bring and extract heat to and from the s/s PCM previously formed.

Another subject matter of the invention is the use of a thermal energy storage device produced by the method as described previously, comprising a thermal energy storage chamber containing at least one s/s PCM and a heat exchanger of the heat-transfer fluid type at least partially disposed in the chamber, characterised by the fact that it comprises a step of use of the heat exchanger for controlling the crystallisation of the s/s PCM in the chamber and a step of using the exchanger for contributing heat to the s/s PCM already formed or for extracting heat from the s/s PCM already formed.

The method according to the invention relates to the manufacture of a thermal energy storage device. The device comprises a storage chamber 1 intended to contain at least one s/s PCM 2. The chamber 1 is conventionally cylindrical in shape, the walls of which are formed by a metal material resistant to variations in pressure and temperature. By way of example, the chamber 1 is made from structural carbon steel. Conventional grades for a pressurised chamber are P235GH, P265GH and P355GH. In the absence of pressure, stainless steels 304 or 316 may be used.

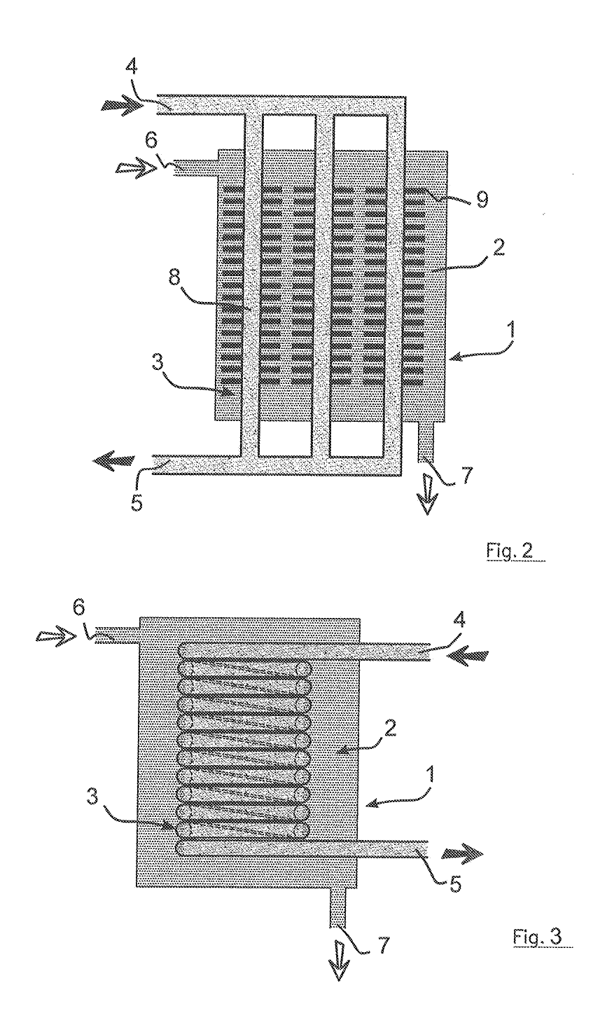

The device comprises a heat exchanger 3 of the heat-transfer fluid type. This heat exchanger 3 is immersed in the chamber 1 of the device. The heat exchanger 3 comprises an inlet 4 and an outlet 5 for the heat-transfer fluid. The inlet 4 and the outlet 5 are arranged outside the chamber 1. The inlet 4 and the outlet 5 may, according to the embodiment, be disposed at two opposite ends of the chamber 1, for example the inlet 4 at the top and the outlet 5 at the bottom, as illustrated in FIGS. 2 and 3, or arranged on the same side, for example at the top. Preferentially, the heat exchanger 3 is at least partially positioned in the chamber 1, preferentially at the centre. The heat exchanger 3 may be of different types, including in particular with finned tubes illustrated in FIG. 2; this type of heat exchanger 3 has the advantage of improving exchanges by conduction and makes it possible to work at high pressure or with a coil illustrated in FIG. 3, which has the advantage of being less expensive, or with plates.

The heat-transfer fluid is conventionally water but any other fluid having heat-transfer properties may be used.

The storage device according to the invention advantageously comprises a device for regulating the temperature of the heat-transfer fluid of the heat exchanger 3. The regulation device makes it possible to control the temperature of the heat-transfer fluid in order to adapt it to the formation of the s/s PCM, in particular in order to effect the crystallisation of the s/s PCM. In addition, the regulation device also makes it possible to control the temperature of the heat-transfer fluid when the energy storage devices is used for contributing and extracting heat to and from the s/s PCM 2 contained in the chamber 1.

According to a preferred embodiment, the chamber 1 comprises interior walls, conventionally metal. The walls are preferentially covered with a cladding material intended to prevent contact between the at least one s/s PCM and metal parts. By way of example, the cladding material is a polymer or a resin, preferentially a material of the fluorinated resin type such as PTFE, FEB or PFA.

This arrangement improves the storage capacities of the s/s PCM while limiting oxidation of the s/s PCM during storage cycles in contact with oxygen and/or metal. Advantageously, this arrangement may also be useful for preventing corrosion of the chamber 1 by the s/s PCM 2 if the latter is corrosive.

The chamber 1 contains at least one s/s PCM 2. Mixtures of s/s PCMs may be used. In this case, at least one s/s PCM of the mixture is formed in the chamber 1. In the remainder of the description, the reference to one s/s PCM is not limitative.

The chamber 1 contains the s/s PCM 2 in the solid state, which surrounds the heat exchanger 3. The heat exchanger 3 is embedded in the s/s PCM 2. In this way, the heat exchanger 3 best recovers the variations in heat of the s/s PCM.

The s/s PCM is a material with two solid phases, where the change between these two phases stores or releases energy. Preferentially, the s/s PCM is a material with two solid phases with a crystalline structure where change from a first crystalline structure to a second crystalline structure will require heat, which is then stored in the s/s PCM in its second crystalline structure. On the other hand, change from the second crystalline structure to the first crystalline structure is exothermic and release said stored heat. When the energy storage device functions in order to store thermal energy, the heat exchanger 3 contributes heat to the chamber 1 and there is an exchange of heat from the heat-transfer fluid to the s/s PCM through the heat exchanger 3. This heat will allow transformation of the s/s PCM from the first crystalline structure to the second crystalline structure, which will then store the heat issuing from the heat-transfer fluid. When the device functions in order to restore thermal energy, the heat exchanger 3 cools the s/s PCM and there is an exchange of heat from the s/s PCM to the heat-transfer fluid through the heat exchanger 3. This allows change from the second crystalline structure to the first crystalline structure. This transformation is exothermic. The heat released is recovered by the heat-transfer fluid.

Advantageously, the change in volume between the two phases of the s/s PCM is around 5% to 10% at the maximum, which is less than for solid/liquid PCMs such as paraffins, where the variation in volume is around 15%. In addition, with an s/s PCM, the change in volume takes place in a homogeneous environment, unlike solid/liquid PCMs, in which a liquid zone must find an expansion path in the middle of a solid. The stresses and therefore the mechanical forces generated, in particular on the chamber 1 and the heat exchanger 3, are therefore lower with an s/s PCM.

Advantageously, in a device manufactured according to the invention, the use of s/s PCMs eliminates the liquid-recirculation movements related to the thermal gradients generated by the fusion of solid/liquid PCM in the chamber 1. However, the presence of temperature gradients in the chamber 1 causes recirculation movements by natural convection of the liquid, causing mechanical stresses on the fins 9 of the tubes 8 of the heat exchanger 3 and on the walls of the chamber 1. According to the invention, the service life of the device is extended by limiting the risks of damage.

According to one embodiment, the s/s PCM may be doped in order to improve its thermal conductivity, that is to say to improve the heat transfer within the s/s PCM. By way of example, doping by means of a dispersoid of carbon or metal fibres may be used. A proportion of fibres of around 5% to 10% by mass of the s/s PCM may be added without risk of settling of the doping particles.

According to another embodiment, graphite particles are added to the s/s PCM so as to allow more effective nucleation and thus limit supercooling. Advantageously undercooling is limited to 10° C. The material may be doped with a very small quantity of graphite powder of around 0.1% by mass in order to create germination sites for the crystals at the phase change. Supercooling means the difference between the liquefaction temperature at the time of heating and that of solidification on cooling. According to another possibility, doping by 3% by mass of nanoparticles of aluminium nitride (AlN) can be carried out.

The filling of the chamber 1 with the s/s PCM material 2 is a critical step with this type of device. This is because the difficultly lies in the optimisation of the void fraction of the chamber 1. However, this void fraction is particularly high when the chamber 1 is filled with an s/s PCM in the solid state. Conventionally, s/s PCM is introduced into the chamber 1 in the form of powder. The void fraction is around 25%. Void fraction means the fraction by volume of the chamber 1 not occupied by the s/s PCM 2. This fraction may be composed of air and/or a neutral gas.

According to the prior art, in order to place an s/s PCM material in a chamber comprising a heat exchanger, the s/s PCM is conventionally liquefied in order to be able to be poured into the chamber. To be liquefied, the s/s PCM is heated beyond its melting point and then the chamber is filled with the liquid s/s PCM.

The inventors have developed a novel method for manufacturing this type of thermal energy storage device. According to the invention, the s/s PCM is formed in the chamber 1 of the device. That is to say it is no longer necessary to synthesise the s/s PCM 2, which is then in the form of a solid, and then to liquefy it by heating and then once again to re-solidify it in the chamber 1 by cooling.

Advantageously, according to the invention at least one step of forming the s/s PCM 2 is carried out in the chamber 1.

Formation step means a step of chemical transformation, that is to say a synthesis step, or a physical transformation step, that is to say a structure-change step such as crystallisation. According to the invention, crystallisation means the precipitation of crystals in a liquid phase.

The formation of an s/s PCM 2 advantageously comprises the successive steps of mixing of the reagents 21, filtration 22 and crystallisation 23.

Preferentially, the method according to the invention comprises at least one crystallisation step 23 carried out in the chamber 1. More preferentially, the method according to the invention comprises at least one crystallisation step 23 and at least one prior filtration step 22, both carried out in the chamber 1. Even more preferentially, the method according the invention comprises at least one crystallisation step 23, at least one prior filtration step 22 and at least one reagent mixing step 21, all carried out in the chamber 1.

According to the invention, the reagents introduced into the chamber 1 in order to form the s/s PCM 2 in the chamber 1 are in the liquid state or at least in the form of a solution. Advantageously, the contacts between the walls of the chamber 1 and the s/s PCM 2 are optimum and guarantee a limited void fraction, preferably less than 10%, and even more preferentially around 1%.

The inventors have perceived that the storage capacities of the storage device by s/s PCM 2 are increased by virtue of the method according to the invention. Without being bound to this reasoning, one explanation would be that, when the s/s PCM 2 is heated beyond its melting point, oxidation is increased, causing a reduction in the reversibility of the s/s PCM 2 between the two solid/solid phases.

Advantageously, the method according to the invention also has the advantage of limiting the risks of damage to the cladding of the internal walls of the chamber 1. This is because, when an s/s PCM 2 heated to the liquid state is introduced into the chamber 1, it is at a temperature higher than its melting point and therefore conventionally at a higher temperature than the maximum temperature of use of the majority of cladding polymers and resins. The latter may be damaged, eliminating their oxidation-protecting effect.

Preferentially, the chamber 1 comprises at least one supply pipe 6 for introducing the reagents for forming the s/s PCM 2. The supply pipe 6 is advantageously placed at the top part of the chamber 1, as illustrated in FIGS. 2 and 3.

Advantageously, the chamber 1 comprises a takeoff device 7 intended to extract the residues issuing from the formation of the s/s PCM 2 in the chamber 1. The takeoff device 7 is preferentially arranged at the lowest point of the chamber 1, as depicted in FIGS. 2 and 3, so as to allow the residues to flow by gravity. The takeoff device 7 comprises drainage means and advantageously filtration means. The drainage means comprise at least one outlet pipe from the chamber 1 associated with at least one valve controlling the opening of the pipe. The filtration means are advantageously disposed outside the chamber 1 so as to be able to be removed, cleaned or changed. The filtration means are intended to retain the solid particles in the chamber 1 and to allow drainage of the liquid residues. By way of example, the filtration means is a sieve with a mesh chosen so as to retain the solid particles of interest.

According to the method of the invention, the heat exchanger 3 is advantageously used as a means for controlling the temperature in the chamber 1 during the formation of the s/s PCM 2 and also as a means of adding and retrieving heat to and from the s/s PCM 2 during the use of the device for storing thermal energy.

According to a first embodiment, the reagents are preferentially premixed before they are introduced into the chamber 1. This premixing is for example carried out by a static mixer inserted by tapping onto the pipe 6 supplying the reagents. This is preferred in the most usual case where the chamber 1 does not have an internal mixer. Thus the premixing and the chemical reaction are carried out in the chamber 1 so that, as described below, the temperature of the reaction is controlled by the heat exchanger 3.

According to a second embodiment, the reagents are mixed before they are introduced into the chamber 1. In this case the reagents are mixed and react outside the chamber 1. The reaction product is introduced into the chamber 1, where then at least one crystallisation step 23 takes place. Preferentially, at least one filtration step 22 also takes place in the chamber 1.

According to a third embodiment, the s/s PCM 2 is synthesised outside the chamber 1 prior to the method according to the invention. The s/s PCM 2 in the solid state is solubilised. This solubilisation is carried out by mixing the s/s PCM 2 with a suitable solvent. This solubilisation differs from the liquefaction carried out in the prior art in which the s/s PCM is heated beyond its melting point in order to become liquid. According to the present embodiment, the s/s PCM is not liquefied but solubilised. There is no alteration of the chemical structure of the s/s PCM.

The solution obtained is next introduced into the chamber 1. At least one crystallisation step 23 next takes place in the chamber 1.

According to the invention, the crystallisation 23 of the s/s PCM 2 in the chamber 1 is a step of crystallisation by evaporation, a step of crystallisation by refrigeration and/or a recrystallisation step.

Pentaerythritol (CAS 115-77-5) is an s/s PCM that can be used in the method according to the invention. Other s/s PCMs such as trimethylol ethane [(CH₃)—C—(CH₂OH)₃] or neopentyl glycol ((CH₃)₂—C—(CH₂OH)₂) or mixtures may be used.

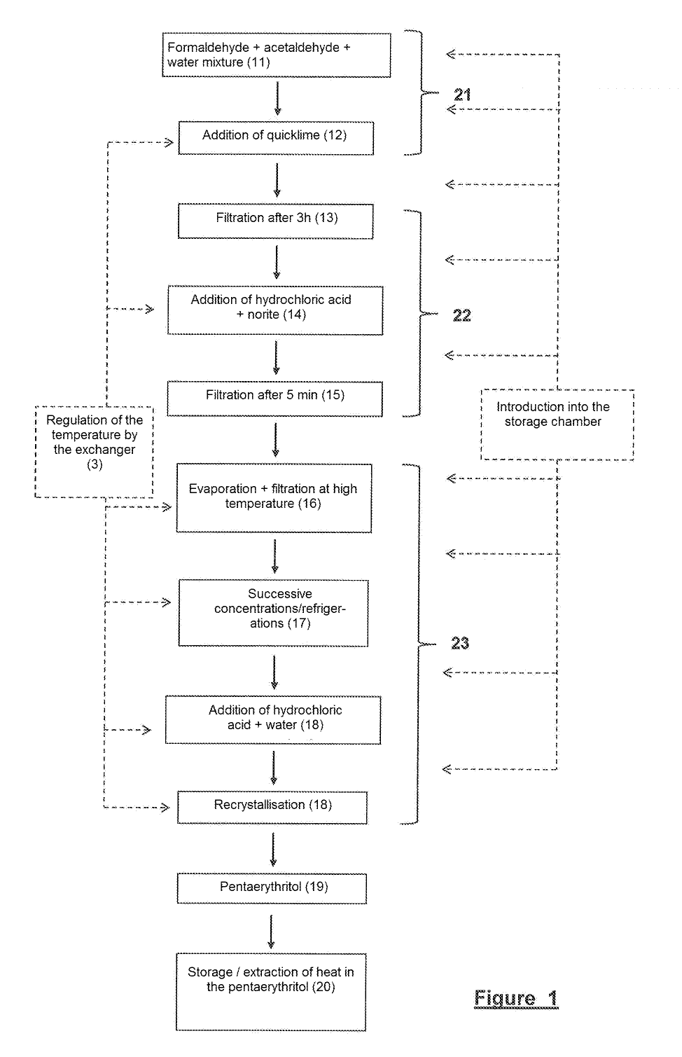

By way of example a flow chart summarising the steps of forming pentaerythritol is shown in FIG. 1.

H₂CO+CH₃—COH+H₂0+CaO→(CH₂OH)₃—C—COH+Ca(OH)₂ (A)

(CH₂OH)₃—C—COH+H₂CO→C—(CH₂OH)₄+HCOOH (B)

Reaction (A) is an aldolisation, that is to say a condensation of aldehyde by reaction between formaldehyde (H₂CO) and acetaldehyde (CH₃—COH) in the presence an excess of water (H₂O).These reagents 11 are mixed in or outside the chamber 1 in accordance with the embodiments described above.

After the reaction and in order to remove a maximum amount of water, calcium oxide (CaO) is added 12 in order to react with the excess water and to form calcium hydroxide. This highly exothermic reaction gives off heat that it is necessary to be able to discharge in order to avoid an excessive increase in the temperature of the reaction medium. According to one possibility, the calcium oxide is introduced little by little into the reactor in order to avoid an excessive release of heat. This is what is referred to as a semicontinuous reactor. This implementation method has the drawback of extending the characteristic operating times. According to another advantageous possibility, and if the mixing of the reagents 21 is carried out in the chamber 1, the reaction heat may be discharged by means of the heat-transfer fluid of the heat exchanger 3.

Filtration steps 22 are necessary for separating the reaction products and extracting the compound (CH₂OH)₃—C—COH.

Reaction (B) is a Cannizarro reaction, that is to say an aldehyde reacts with an aldehyde followed by crystallisation steps 23 in order to form an alcohol.

In order to concentrate and extract the crystallised phases and in particular the pentaerythritol, concentration/refrigeration steps 17 are implemented. Crystallisation takes place at around 5°-10° C. Preferentially, a recrystallisation step 19 is carried out in order to homogenise and purify the structure of the s/s PCM 2.

Advantageously, at least the recrystallisation step 19 is carried out in the chamber 1.

Even more advantageously, at least the successive concentration/refrigeration steps 17 are also carried out in the chamber 1.

Even more advantageously, at least one filtration step 13 or 15 is also carried out in the chamber 1. Even more advantageously, at least one step of mixing the reagents 11 or 12 is carried out in the chamber 1.

A method for manufacturing an energy storage device according to the invention can be established for storing heat on an urban or industrial heat system. Storage device chambers 1 can be installed in order to accumulate heat and respond to the peak demand in the morning and evening on heat systems supplying hot water for heating or for domestic hot water. According to the transition temperature level of the s/s PCM, the thermal energy storage device is arranged either on the main loop of the high-temperature high-pressure boiler, for example water superheated to 160° C. at 20 bar pressure, or on the secondary loops supplying the dwellings, for example at a temperature of 60°-80° C. and at a pressure of 1 bar.

In this case, chambers with a size of around 10 m³ are disposed in the substations where heat is exchanged between the main loop and the secondary loop.

According to the invention, a thermal energy storage device according to the invention with an s/s PCM such as pentaerythritol makes it possible to store between 60 and 100 kWh/m³ per chamber. By way of information, a chamber with an integrated heat exchanger comprising a solid/liquid PCM such as stearic sebacic acids makes it possible to store 40 to 50 kWh/m³ per chamber.

The manufacturing method according to the invention affords an increase in the quantity of energy stored per unit volume or, for a given quantity of heat, a reduction in the volume of the chamber.

According to one embodiment, the filling of the chamber 1 and the steps of forming the s/s PCM are preferentially carried out in the factory. Once the s/s PCM is crystallised in the chamber 1, the latter is transported to the energy storage place, for example in the substations of a heat system. The heat exchanger 3 is next connected to the fluid system in order to start the functioning.

This method has the advantage of not having to carry out a filling of the s/s PCM in the liquid state on the thermal energy storage site. This is because it is a complicated and expensive operation since it is necessary on each occasion to bring a melting furnace, to melt the s/s PCM in the furnace situated not far from the chamber 1, and then to transfer the liquid into pipework traced as far as the chamber and to repeat this for each chamber.

### EXAMPLE 1

### Pentaerythritol Formation Method

The reagents are mixed (21) in order to form a suspension of paraformaldehyde.

Quicklime (12) is added. The temperature is preferentially controlled so as to rise to 50° C. in 30 minutes, maximum 55° C. The mixture adopts a slightly yellow colour. Once the addition is terminated, agitation can be continued for three hours. The mixture is filtered (13) by gravity. Dilute hydrochloric acid (14) is added in order to give an acid reaction. Norite is also added. After five minutes, which may be under agitation, the solution is filtered (15).

The liquor is heated, for example over a steam bath at atmospheric pressure, and filtration is carried out under hot pumping. The crystals that remain on the filter are washed by suction (17) through wet steam (16). The filtrate is left to rest cold for one night and the first harvest of crystals is obtained by filtration. Several successive harvestings can be carried out.

### REFERENCES

1. Chamber
2. s/s PCM
3. Heat exchanger
4. Heat-transfer fluid inlet
5. Heat-transfer outlet
6. Supply pipe
7. Takeoff device
8. Tube
9. Fin
11. Formaldehyde+acetaldehyde+water mixture
12. Addition of quick lime
13. Filtration after 3 hours
14. Addition of hydrochloric acid+norite
15. Filtration after 5 minutes
16. Evaporation+filtration at high temperature
17. Successive concentrations/refrigerations
18. Addition of hydrochloric acid+water
19. Recrystallisation
20. Pentaerythritol
21. Mixing of reagents
22. Filtration
23. Crystallisation

1. A method for producing a thermal energy storage device by means of at least one solid/solid phase change material comprising a thermal energy storage chamber containing the at least one solid/solid phase change material and a heat exchanger, with heat-transfer fluid for storing and extracting the heat of said solid/solid phase change material, immersed in said chamber, wherein at least one step of forming the at least one solid/solid phase change material is performed inside the storage chamber, the at least one formation step comprising at least one crystallisation step.

2. The method according to claim 1, wherein the at least one formation step comprises a concentration step performed inside the storage chamber.

3. The method according to claim 1, wherein the at least one formation step comprises a filtration step performed in the storage chamber.

4. The method according to claim 1, wherein the at least one formation step comprises a step of mixing the reagents performed in the storage chamber.

5. The method according to claim 1, wherein the reagents for the formation of the at least one solid/solid phase change material are introduced into the chamber through at least one supply pipe.

6. The method according to claim 1, wherein liquid residues issuing from the formation of the at least one material are extracted from the chamber through at least one takeoff device.

7. The method according to claim 1, wherein the heat exchanger with heat-transfer fluid is used for controlling the temperature inside the chamber during the formation of at least one solid/solid phase change material.

8. The method according to claim 7, wherein the heat exchanger is configured so as to control the crystallisation of the solid/solid phase change material inside the chamber.

9. The method according to claim 1, wherein the at least one solid/solid phase change material is solubilised in a solvent and then introduced into the storage chamber, and then at least one step of crystallisation of the solid/solid phase change material is performed inside the chamber.

10. The method according to claim 1, comprising a prior step of covering the interior metal walls of the chamber with a cladding material intended to prevent contact between the at least one solid/solid phase change material and the metal walls of the chamber.

11. The method according to claim 1, comprising a step of doping the at least one solid/solid phase change material carried out in the chamber.

12. The method according to claim 1, wherein the at least one solid/solid phase change material is pentaerythritol.

13. A method for producing a thermal energy storage installation on an operating site, wherein it comprises:
the production of a thermal energy storage device according to the method claim 1;
transportation onto the operating site of the device produced, the chamber of which is filled with solid/solid phase change material;
connection of the heat exchanger of the device to the fluid system for starting the thermal energy storage.

14. A thermal energy storage device produced by the method according to claim 1, comprising a thermal energy storage chamber containing at least one solid/solid phase change material and a heat exchanger of the heat-transfer fluid type at least partially disposed in the chamber, characterised by the fact that it comprises a device for regulating the temperature of the heat-transfer fluid so as to be configured in order:
in a configuration of formation of the at least one solid/solid phase change material, to control the temperature of the heat-transfer fluid in order to cause crystallisation of the solid/solid phase change material;
in a use configuration, to control the temperature of the heat-transfer fluid in order to bring and extract heat to and from the solid/solid phase change material previously formed.

15. Use of a thermal energy storage device produced by the method according to claim 1, comprising a thermal energy storage chamber containing at least one solid/solid phase change material and a heat exchanger of the heat-transfer fluid type at least partially disposed in the chamber,
wherein it comprises
a step of use of the heat exchanger for controlling the crystallisation of the solid/solid phase change material in the chamber,
a step of using the exchanger for contributing heat to the at least one solid/solid phase change material formed or for extracting heat from the at least one solid/solid phase change material formed.
